(19) United States
(12) Patent Application Publication
(10) Pub. No.: US 2013/0327432 A1
(43) Pub. Date: Dec. 12, 2013

(54) Fluid Conveyance Joint

(71) Applicant: Norton McMurray Manufacturing Company, Geneva, IL (US)

(72) Inventors: Glenn McMurray, St. Charles, IL (US); John C. Justice, Elburn, IL (US)

(21) Appl. No.: 13/910,684

(22) Filed: Jun. 5, 2013

Related U.S. Application Data
(60) Provisional application No. 61/658,128, filed on Jun. 11, 2012.

(51) Int. Cl. F16L 21/00

(52) U.S. Cl. CPC F16L 21/00
USPC 138/109; 29/890.14

(57) ABSTRACT

A transition fitting includes an exterior casing and a flexible fluid conveyance tube at least partially disposed radially interior the exterior casing. A stiffener is radially interior the flexible fluid conveyance tube. A first crimp extends radially interior from the interior surface of the exterior casing. A first annular retention device extends radially between the flexible fluid conveyance tube and the exterior casing and engages the first crimp. A gasket is disposed axially between the first annular retention device and a second annular retention device. A second crimp extends radially interior from the interior surface of the exterior casing and engages the second annular retention device. The second crimp secures the gasket between the first and second annular retention devices such that the gasket forms a fluid tight seal between the flexible fluid conveyance tube and the exterior casing.

### CROSS REFERENCE TO RELATED APPLICATION

This application relates to and claims priority from U.S. Provisional Application Ser. No. 61/658,128 filed on Jun. 11, 2012, which is hereby incorporated by reference in its entirety.

### BACKGROUND

Gas risers conduct natural gas from an underground gas source to an installment, such as a residence or commercial building being serviced with natural gas.

Gas is conducted in flexible tubing, exemplarily polyethylene (PE) flexible tubing, while underground. When conveyed underground, the earth protects the tubing from physical and UV damage. However, when the tubing is directed above ground, such as along a building, a riser that encloses the flexible tubing within a metal casing is preferred to ensure the safety of the flexible tubing. Above ground piping to convey natural gas is metallic. A riser contains a transition joint connecting the flexible tubing to the metallic pipe gas carrying portion of the riser. Thus, the riser serves to transition from below the ground plastic tubing to above ground metallic pipe.

Gas risers present particular challenges as a long-term gas-tight seal must be maintained, while protecting the flexible tubing when it is above ground. The gas tight seal must be maintained despite the differences in hardness and deformation properties exhibited between the various components of the transition joint. In addition to the gas tight seal, it is also a challenge to secure the flexible tubing to the metallic riser such that the tubing does not pull out from the transition joint.

Often solutions have used a combination of single or multiple elastomeric seals which may be O-rings between the flexible tubing, and the metal casing to create the gas-tight seal. One problem with this solution is that typically a dimension, such as an outside diameter of the flexible tubing or elastomeric seal, is more closely controlled through manufacturing quality assurance, than the respective inside diameters of the mating structures. This presents the practical challenge that, despite a properly dimensioned elastomeric seal outside diameter, if the inside, diameter of the elastomeric seal is larger than average, a loose or incomplete, seal can occur between the elastomeric seal and flexible tubing which presents the risk of leakage. Similarly, if the outside diameter of the elastomeric seal is smaller than average, a similar loose or incomplete seal between the elastomeric seal and the interior diameter of the metal casing can occur.

A further disadvantage of these previous systems is that the elastomeric seal declines in sealing force over time due to progressive stress relaxation. In progressive stress relaxation, the elastomeric material of the elastomeric seal degrades over time. Progressive stress relaxation can eventually result in failure of the elastomeric seal to provide a required seal. Elastomer materials are also known to suffer from cold flow, which is the gradual creep of the elastomer material under compression through annular spaces. This gradual displacement occurs over the lifetime of the product and can eventually result in a loss of sealing force.

### BRIEF DISCLOSURE

One embodiment of a transition fitting disclosed herein includes an exterior casing. The exterior casing has a first crimp that extends radially from an interior surface of the exterior casing. A flexible fluid conveyance tube is partially disposed radially interior the exterior casing. A first end of a flexible fluid conveyance tube is located radially interior the exterior casing. A stiffener is radially interior the flexible fluid conveyance tube and engages the flexible fluid conveyance tube. A first annular retention device is radially exterior the flexible fluid conveyance tube. The first annular retention device extends radially between the flexible fluid conveyance tube and the exterior casing. The first annular retention device engages the first crimp which prevents axial translation of the first annular retention device. A second annular retention device is positioned axially to the flexible fluid conveyance tube and engages the flexible fluid conveyance tube. The second annular retention device extends radially in the direction of the exterior casing. A gasket is disposed axially between the first annular retention device and second annular retention device. The gasket is disposed radially between the flexible fluid conveyance tube and the exterior casing. A crimp extends radially interior of the interior surface of the exterior casing and engages the second annular retention device. The second crimp secures the gasket between the first and second annular retention devices such that the gasket forms a fluid tight seal between the flexible fluid conveyance tube and the exterior casing.

In an alternative exemplary embodiment, a transition fitting includes an exterior casing. A flexible fluid conveyance tube includes a first end that terminates at a fluid source and a second end that terminates within the exterior casing. The flexible fluid conveyance tube is radially disposed at least partially within the exterior casing. A first annular retention device is radially disposed between the flexible fluid conveyance tube and the exterior casing. A stiffener is located radially interior to the flexible fluid conveyance tube. The stiffener includes a second annular retention device that extends radially outward in the direct of the exterior casing along the second end of the flexible fluid conveyance tube. An elastomeric gasket is radially disposed between the flexible fluid conveyance tube and the exterior casing. The elastomeric gasket is axially disposed between the first annular retention device, and the second annular retention device. A first radial crimp in the exterior casing engages the first annular retention device and prevents axial displacement of the first annular retention device in the direction of the first end of the flexible fluid conveyance tube. A second radial crimp in the exterior casing places the elastomeric gasket in an axially compressed condition when an axial force is applied to the second annular retention device. The second radial crimp engages the second annular retention device to secure the elastomeric gasket in the axially compressed condition.

An exemplary embodiment of a method of forming a transition fitting between a flexible fluid conveyance tube and an exterior casing includes crushing a first radial crimp in the exterior casing. The first radial crimp extends radially interior of the exterior casing. The flexible fluid conveyance tube is positioned within the exterior casing. The first annular retention device and a gasket are inserted radially between the first fluid conveyance tube and the exterior casing. A stiffener is inserted into the flexible fluid conveyance tube. A second annular retention device is inserted radially interior of the exterior casing. An axial force is applied against the second annular retention device and stiffener. The gasket is compressed to a target hydraulic pressure. A crimper is positioned relative to the second annular retention device. A second radial crimp is crushed into the interior casing, the second radial crimp engaging the second annular retention device.

### BRIEF DESCRIPTION OF THE DRAWINGS

FIG. 1 is a system diagram that depicts embodiments of transition fittings in non-limiting uses.

FIG. 2 depicts an exemplary embodiment of a transition fitting.

FIG. 3 depicts an exemplary alternative embodiment of a transition fitting.

FIG. 4 depicts a still further exemplary embodiment of a transition fitting.

FIG. 5 is a flow chart that depicts an embodiment of a method of constructing a fluid conveyance joint in a transition fitting.

### DETAILED DISCLOSURE

In the present description, certain terms have been used for brevity, clearness, and understanding. No unnecessary limitations are to be implied therefrom beyond the requirement of the prior art because such terms are used for descriptive purposes only and are intended to be broadly construed. The different systems and methods described herein may be alone or in combination with other systems and methods. Various equivalents, alternatives, and modifications are possible within the scope of the appended claims. Each limitation in the appended claims is intended to invoke interpretation under 35 USC §112, sixth paragraph, only if the terms “means for” or “step of” are explicitly recited in the respective limitation.

As used herein, the term “joint” is to refer to a connection between piping components employing physical force to develop a seal or produce alignment.

As used herein, the term “fitting” is to refer to a piping component used to join or terminate sections of pipe orb provide changes of direction or branching in a pipe system.

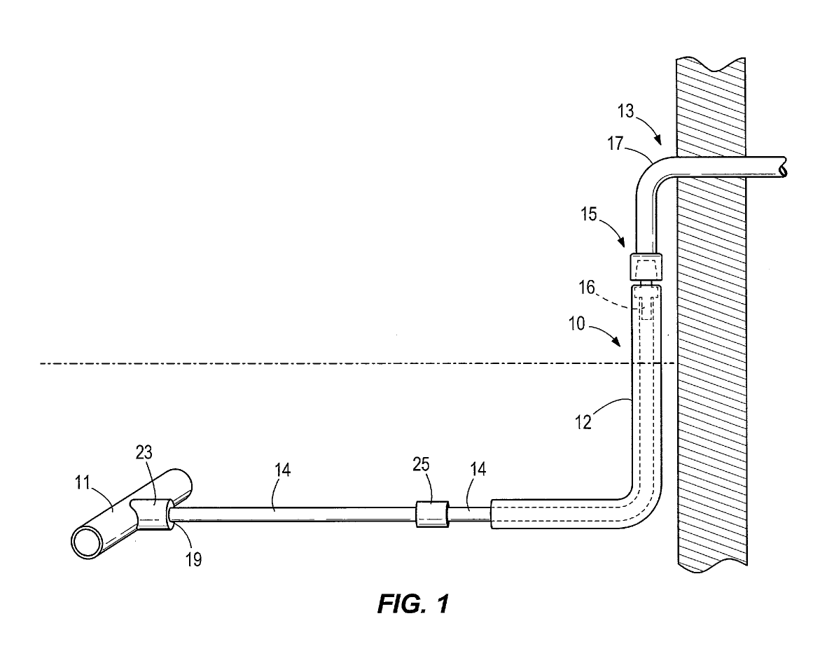

FIG. 1 is a system diagram that depicts embodiments of transition fittings used in accordance as disclosed herein. Transition fitting 23 generally includes a fluid conveyance joint that joins tubing or conduit of different material. In one non-limiting example, a transition fitting 23 connects the metallic main line 11 to a flexible fluid conveyance tube 14. Another specific embodiment of a transition fitting is a fluid conveyance riser 10, which by way of example will be described in greater detail herein. The riser 10 includes an exterior casing 12. The exterior casing 12 is exemplarily steel pipe. However, it will be recognized that alternative embodiments may use other materials, including other metal alloys, polymers, or resins. Within the exterior casing 12 is disposed a flexible fluid conveyance tube 14. The flexible fluid conveyance tube 14 has a first end 19 that connects to the natural gas source and a second end 16 that terminates within the exterior casing 12. The flexible fluid conveyance tube 14 is exemplarily polyethylene; however it will be understood that other polymeric or elastomeric materials may be used in embodiments including, but not limited to, polyamide materials. In some embodiments, the flexible fluid conveyance tube 14 may comprise multiple tube segments connected by a fitting 25 that includes one or more joints between the tube segments and the fitting to connect adjacent tube segments to one another.

The riser 10, as disclosed herein, can be used to convey any of a variety of liquid or gaseous fluids, including, but not limited to, natural gas or water. The present disclosure will focus on the specific embodiments of natural gas conveyance, however, a person of ordinary skill in the art will recognize that the embodiments as disclosed herein can be used to convey other liquid or gaseous fluids and the current disclosure is not limited to the conveyance of natural gas.

As depicted in FIG. 1, the flexible fluid conveyance tube 14 is connected to a natural gas source, which may exemplarily be a natural gas utility main line 11. The flexible fluid conveyance tube 14 extends underground from the natural gas source to an installation 13, exemplarily a residential or commercial building. A connection 15 transfers the conveyance of the natural gas from the riser 10 to a metal pipe 17 as used throughout the installation 13.

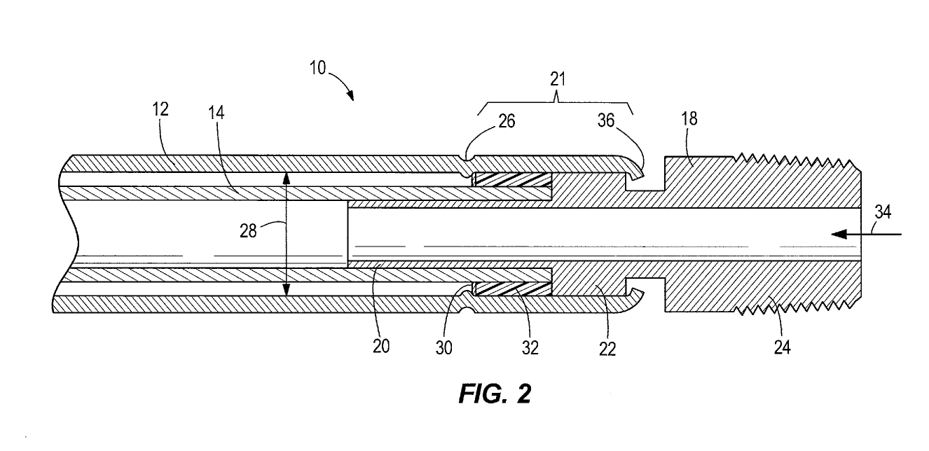

FIG. 2 presents a more detailed view of one embodiment of the riser 10. A joint 21 sealingly secures the flexible fluid conveyance tube 14 to the exterior casing 12. The joint 21 includes an adapter 18 is that partially inserted into the exterior casing 12. Embodiments of the adapter 18 include a stiffener 20, an annular retention device 22 and a connection end 24. In the embodiment of the riser 10 as depicted in FIG. 1, the connection end 24 is a threaded connection, exemplarily NPT thread; however, other embodiments of the connection end 24 may include a valve, flange, or other connectors as would be recognized by one of ordinary skill. While the adapter 18 is depicted as being a unitary structure, it is understood that in alternative embodiments, the stiffener 20, annular retention device 22, and connection end 24 may be separate components, or alternative combinations of these components, some embodiments of which are disclosed herein.

One advantage of this embodiment that includes an adapter 18 is that adapters of various sized and configured connection ends 24 (to compliment metal pipe 17 of FIG. 1) may be selected to effectively enable the fabrication of a riser to meet the transition needs in the riser 10 to upsize or downsize the natural gas conduit to facilitate connection of the installation 13 to the above ground metal piping. Another advantage of the joint 21 is minimizing potential leak-paths and therefore additional seals.

A first annular crimp 26 is placed in the exterior casing 2, such that the first a annular crimp 26 extends radially interior to the exterior casing inside diameter 28. An annular retention device 30, which is exemplarily a washer, but can include other annular retention devices 30 as disclosed herein, is inserted in to the exterior casing 12 and disposed radially between the exterior casing 12 and the flexible fluid conveyance tube 14. The annular retention device 30 axially engages the first annular crimp 26, which prevents the annular retention device 30 from axially moving an further down the exterior casing 12. A gasket 32 is seated radially between the exterior casing 12 and the flexible fluid conveyance tube 14 and seated against the annular retention device 30. The gasket 32 can be constructed of a variety of elastomers.

The adapter 18 is inserted into the exterior casing 12 such that the stiffener 20 extends radially interior of both the exterior casing 12 and the flexible fluid conveyance tube 14 until the annular retention device 22 engages the gasket 32. In some embodiments, the annular retention device 22 also engages the second end 1 of the flexible fluid conveyance tube 14 upon insertion. In construction of the riser 10, an axial force in the direction of arrow 34 is placed on the adapter 18 while the casing 12 is held stationary which compresses the gasket 32 between the annular retention device 30, exterior casing 12, and annular retention device 22. The gasket 32 is further compressed against the flexible fluid conveyance tube 14. Due to the flexible qualities of the material of the flexible fluid conveyance tube 14, the flexible fluid conveyance tube 14 also experiences compression forces radially applied against the flexible fluid conveyance tube 14 by the compressed gasket 32, such that the flexible fluid conveyance tube 14 seemingly engages the stiffener. In some embodiments, the stiffener 20 includes a plurality of barbs or ridges not depicted) that further facilitate the securing engagement of the flexible fluid conveyance tube 14 to the stiffener 20. While described herein as barbs or ridges, it is understood that other embodiments may use other structures designed to engage the flexible fluid conveyance tube such as, but not limited to knurls or screw threads. A second annular crimp 36 in the exterior casing 12 engages the annular retention device 22 on a side opposite from the gasket 32. This secures the gasket 32 in the compressed configuration and the axial force in the direction of arrow 34 can be released.

In embodiments, the axial force applied in the direction of arrow 34 is at least 1,000 pounds. In still further embodiments, the axial force applied in the direction of arrow 34 is 3,000 pounds. However, in still further embodiments, the axial force could be greater than 3,000 pounds, and in still further embodiments, the axial force could be 10,000 pounds or greater. The axial force applied in the direction of arrow 34 creates a substantial hydraulic force, exemplarily greater than 1,000 psi within the gasket. The hydraulic force within the gasket will be a function of the axial force applied and could in embodiments be greater than 10,000 psi.

The tremendous amount of pressure applied to the adapter 18 causes the adapter to axially translate within the exterior casing 12. When the adapter 18 reaches a positional equilibrium between the compressed gasket 32 and the axial force 34, the second crimp 36 is placed in the exterior casing 12 to engage the annular retention device 22 and hold the adapter 18 in the equilibrium position, maintaining the hydraulic force within the gasket. In an embodiment, the second crimp 36 is placed in the exterior casing 12 axially distal the annular retention device 22 such that the annular retention device 22 is not damaged by the second crimp 36, yet the gasket 21 is held in the compressed condition. An advantage exists in the process of manufacture as described further herein and the resulting product. Prior art devices relied solely upon precisely controlled manufacturing dimensions and tolerances of various components and therefore achieved minimal amounts of hydraulic pressure in gasket. However, the transition fitting as disclosed herein accommodates dimensional and other variations of the components by controlling the hydraulic pressure in the gasket by controlling the axial pressure exerted in the direction of arrow 34, then adjusting where the second annular crimp 36 is made to assure the target hydraulic pressure is maintained independent of the size, hardness, or other properties of the various components.

As disclosed herein, the gasket 32 is captured and constrained in the compressed configuration in a manner that achieves improved riser performance. The compressed gasket 32 is constrained in all directions which minimizes the aforementioned cold flow problem of the elastomeric material of the gasket 32. Also, the greater volume of the material in the gasket 32, and the higher compression pressure under which the gasket 32 is held increases longevity of the seal even as the elastomeric material in the gasket begins to experience progressive stress relaxation. This is a particular advantage in the relatively low pressure found in natural gas distribution systems. Surprisingly, higher pressure distribution systems, exemplarily hydraulic pressure systems, achieve greater seal strength and longevity compared to low pressure systems, when similar prior art sealing systems are used. The inventors have observed that this is due to the fact that the higher fluid pressure in the hydraulic distribution system adds an additional compression component on the elastomeric seals. This compression component is not present or is minimally present in low pressure natural gas delivery systems.

In an exemplary description, as the axial force 34 against the adaptor 18 increases the hydraulic force experienced within the compressed gasket increases exponentially and becomes asymptotic. In an embodiment, it is desirable to apply an axial force such that the hydraulic force approaches this limit this serves to maximize potential energy stored within the gasket which in embodiments, the inventors have discovered contributes to increased performance and longevity in the resulting joint. An exemplary calculation of forces experienced within the embodiment are set forth below. The area of the gasket surface receiving the axial force (A_{g}) can be calculated with the following equation:

A_{g}=π/4(D2²−D1²) Eq. 1

The axial pressure applied to the gasket (P_{g}) can be calculated by the following equation:

P_{g}=F/A_{g} Eq. 2

wherein F is the axial force in pounds applied to the gasket, D1 is the outside diameter of the gasket in inches, and D2 is the inside diameter of the fluid gasket in inches. In a merely exemplary embodiment, F equals 10,962 pounds, D1 equals 1.380 inches, and D2 equals 1.125 inches. Applying these merely exemplary values to the above equations, results in the calculation of the axial pressure applied to the gasket being 21,850 psi.

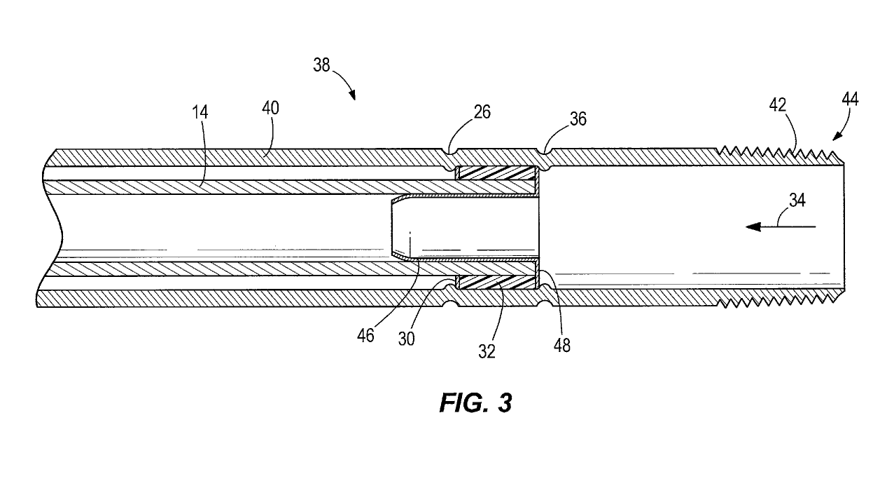

FIG. 3 depicts an alternative embodiment of a riser 38. It will be recognized that in the alternative embodiments depicted in the figures herein, like reference numerals are used to identify like structures between the embodiments such as to efficiently focus on the features of each of the embodiments. The riser 38 includes an exterior casing 40. The exterior casing 40 differs from that depicted in FIG. 2 as the threads 42 of the connection end 44 are integrally formed into the exterior casing 40, rather than provided in a separate adapter component.

Likewise, a stiffener 46 is a separate component from the connection end 44. The stiffener 46 includes an annular retention device 48 that extends radially away from the stiffener 46, although annular retention device 48 is thinner in the axial direction than the annular retention device 22 in FIG. 2.

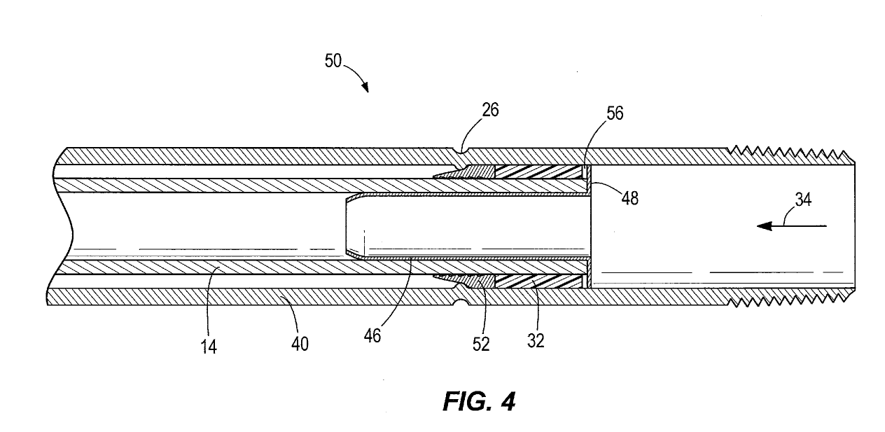

It is to be noted that in the embodiment depicted, the first radial crimp extends radially inwards of the exterior casing, but stops short of the flexible tubing 14. This may present further utility as explained further with respect to FIG. 4; however, in alternative embodiments, the first radial, crimp may extend to the flexible tubing 14.

The annular retention device 48 operates in a similar manner as that found in the embodiment of FIG. 2 in that the gasket 32 is captured and constrained under compression between the annular retention device 30 and the annular retention device 48. The second annular crimp 36 holds the annular retention device such that the gasket 32 is captured and constrained in the compressed configuration. It will be noticed that the thickness of the annular retention device 48 in the axial dimension is thinner than that of the annular retention device 22 in FIG. 2 and it will be noted that the second annular crimp 36 is placed in the exterior casing 40 in relation to the annular retention device 48 such as to secure the gasket 32 in the compressed condition. In both of the embodiments of FIGS. 2 and 3, it is to be noted that the second annular crimp 36 is placed in the exterior casing relative to the actual position of the annular retention device 22 or 48, as described in further detail above.

FIG. 4 depicts a still further embodiment of the riser 50, similar to that depicted in FIG. 3. The difference in the riser 50 of FIG. 4 twin the riser 38 in FIG. 3 is that the riser 50 replaces the embodiment of the annular retention device 30 which is exemplarily shown as a washer in FIG. 3 with an annular retention device that is instead a grip ring 52. The grip ring 52 is similarly positioned radially between the exterior casing 40 and the flexible fluid conveyance tube 14. However, the grip ring 52 is elongated in the axial dimension compared to the washer depicted in FIG. 3. In addition to the elongation of the grip ring 52 in the axial dimension, the grip ring 52 varies in radial width such as to form a ramp or wedge shape. This annular retention device can further facilitate to capture and constrain compression of the gasket 32. Thereby the grip ring 52 moves into a secured engagement between the flexible fluid conveyance tube 14 and the first annular crimp 26 of the exterior casing 40. The grip ring 52 further facilitates preventing pull on of the flexible fluid conveyance tube 14 from connection to the exterior casing 12. The grip ring 52 can facilitate preventing pull out by complimenting the barbs or other features on the stiffener and similarly engaging the flexible fluid conveyance tube from the outer surface. Still further embodiments may comprise both an annular retention device and a grip ring to lend strength, longevity, or axial width to the grip ring.

it is further to be noted that the embodiment of the riser 50 depicted in FIG. 4 shows the gasket 32 in the uncompressed configuration as evidenced by the gap 56 between the annular retention device 48 and the gasket 32. As detailed above, an axial force applied in the direction of arrow 34 on the stiffener 46 and annular retention device 48 moves the stiffener 46 and annular retention device 48 in the direction of arrow 34 until the flexible fluid conveyance tube 14 and the gasket 32 are engaged and further pressure in the direction of arrow 34 compresses and captures the gasket 32 in the constrained space defined between the grip ring 52, annular retention device 48, exterior casing 40, and flexible fluid conveyance tube 14 through the stiffener 46. Once the gasket 32 is in a fully compressed state the gap 56 is closed and a second annular crimp, as depicted in FIG. 3, is placed in the exterior casing 40 to engage and secure the annular retention device 48 in a position that maintains the compressed configuration of the gasket 32.

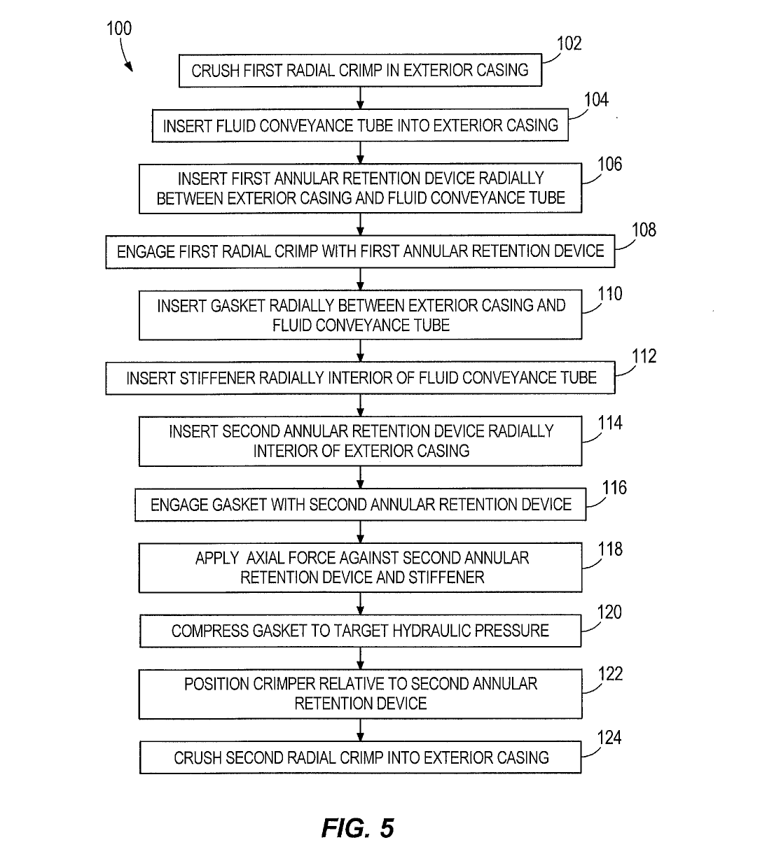

FIG. 5 is a flow chart that depicts an embodiment of a method 100 of manufacturing a fluid conveyance joint, exemplarily a transition fitting in a riser. The method 100 begins at 102 when a first radial crimp is crushed into an exterior casing of a riser. The exterior casing is exemplarily a steel pipe as described above and the first radial crimp can be made in the exterior casing exemplarily with an arbor press; however, it will be recognized by those of ordinary skill in the art that alternative devices for manufacturing such a radial crimp could be used. Next, at 104 a fluid conveyance tube is inserted into the exterior casing. As described above, the fluid conveyance tube can be a flexible fluid conveyance tube exemplarily constructed of polyethylene. The fluid conveyance tube is inserted into the exterior casing, but the fluid conveyance tube terminates within the exterior casing at a position beyond the first radial crimp.

A first annular retention device is inserted radially between the exterior casing and the fluid conveyance tube at 106. As described above, in one embodiment, the first annular retention device is a washer, while in another embodiment, the first annular retention device is a grip ring. The first annular retention device engages the first radial crimp at 108 in the position radially between the exterior casing and the fluid conveyance tube.

At 110, an elastomeric gasket is inserted radially between the exterior casing and the fluid conveyance tube. In embodiments, the elastomeric gasket also engages the first annular retention device.

At 112, a stiffener is inserted radially interior of the fluid conveyance tube and at 114 a second annular retention device is inserted radially interior of the exterior casing. In embodiments, the stiffener and the annular retention device are integrally connected and the stiffener is inserted into the fluid conveyance tube so far as until the second annular retention device engages at least one of the end of the fluid conveyance tube or the elastomeric gasket.

At 116 the second annular retention device engages the gasket. An axial force is applied at 118 against the second annular retention device and stiffener. In an embodiment, the axial force is applied against the second annular retention device and the stiffener by a hydraulic press. The hydraulic press may generate at least 1,000 pounds of force against the second annular retention device and stiffener, while in other embodiments, the hydraulic press applies greater than 3,000 pounds of force or more, and in still further embodiments, the axial force is 10,000 pounds or more. The axial force applied by the hydraulic press is selected and adjusted to achieve a target hydraulic force within the gasket. This hydraulic force is exemplarily greater than 1,000 psi, and in embodiments, can be greater than 10,000 psi.

The application of the axial force against the second annular retention device and stiffener at 118 compresses the gasket at 120. The gasket is captured and constrained between the fluid conveyance tube, exterior casing, first annular retention device, and second annular retention device and is physically compressed to be captured and constrained within the volume defined by these structures. This creates a seal between the fluid conveyance tube and the exterior casing. This also stores potential energy from the hydraulic force in the compressed gasket. Additionally, the axial compression of the gasket at 120 creates a force in the radial direction against the fluid conveyance tube. This radial force applied by the gasket secures the fluid conveyance tube to the stiffener. The first annular retention device and second annular retention device are dimensioned to capture and constrain the compressed gasket in a minimized annular space with minimized gaps between the structures facilitated by the first and second crimps. The minimized annular space or gaps eliminates or substantially reduces cold flow of the gasket over time.

The axial force applied at 118 against the second annular retention device and stiffener is a force selected to achieve a target hydraulic pressure within the gasket. As the gasket is compressed at 120, the hydraulic pressure of the gasket increases and the force in the axial direction can be adjusted in order to achieve the target hydraulic pressure at the gasket. Under the applied axial force, the gasket, stiffener, and second annular retention device reach at equilibrium and the second annular retention device reaches a steady state position at this equilibrium associated with the gasket being held at the target hydraulic pressure.

In one exemplary embodiment, at 122 the crimper is positioned about the exterior casing in relation to the actual position of the second annular retention device. Thus, the alignment of the crimper at 122 is dependent upon the location of the steady state position achieved by the second annular retention device. When the crimper is aligned with the second annular retention device, the second radial crimp is crushed into the exterior casing at 124.

At 124 a second radial crimp is crushed into the exterior casing. The second radial crimp can similarly be crushed into the exterior casing, by the crimper which may be an arbor press as described above. The alignment of the crimper with the second annular retention device means that the second radial crimp is placed in the exterior casing, at a position such that the second radial crimp engages the second annular retention device. The second radial crimp is placed in the exterior casing engages the axial force is still applied against the second annular retention device. The second radial crimp secures the second annular retention device in a position that maintains the elastomeric gasket in the compressed configuration after release of the axial force against the second annular retention device.

In some embodiments, the second radial crimp is located in the exterior casing at a position dependent upon the position of the second annular retention device. Therefore, these embodiments require determining the position of the second annular retention device where the second annular retention device achieves an equilibrium against the elastomeric gasket wider the applied axial force. The second radial crimp is then crushed into this location on the exterior casing. In embodiments, the second radial crimp is located at a position slightly distal, or towards the end of the casing from the position of the second annular retention device. This crimp location can avoid causing damage to the second annular retention device when the second radial crimp is made, while still holding the gasket in the compressed configuration.

It is to be noted that while the actions identified at 104-116 are set forth in a particular order, alternative embodiments within the scope of the present disclosure may perform those actions in a variety of sequences so long as the same functional result is achieved. In one such non-limiting embodiment, the fluid conveyance tube is passed all the way through the exterior casing. Once the end of the fluid conveyance tube is outside of the exterior casing, the first annular retention device and gasket can be passed over the end of the fluid conveyance tube and the stiffener inserted radially interior of the fluid conveyance tube. The first annular retention device, gasket, stiffener, and second annular retention device are then all positioned back within the exterior casing as the fluid conveyance tube and exterior casing are moved relative to one another to position these structures radially interior of the exterior casing. Similar implementations of these functions and achieving these actions will be recognized by one of ordinary skill in the art.

Some embodiments as disclosed herein provide the advantage of creating a seal with great structural longevity. The great amount of compression placed upon the gasket stores a substantial amount of potential energy within the gasket. Because the gasket is captured and constrained against cold flow and creep, this potential energy maintains the seal while the natural decline in hydraulic sealing force must progress for a far longer time than designs utilizing smaller gaskets under little compression and that allows elastomeric gasket to flow and creep into adjacent gaps and voids.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A transition fitting comprising:
an exterior casing having a first crimp extending radially interior from an interior surface of the exterior casing;
a flexible fluid conveyance tube at least partially disposed radially interior the exterior casing such that a first end of the flexible fluid conveyance tube is located radially interior the exterior casing;
a stiffener radially interior the flexible fluid conveyance tube, the stiffener engages the flexible fluid conveyance tube;
a first annular retention device radially exterior the flexible fluid conveyance tube, the first annular retention device extending radially between the flexible fluid conveyance tube and the exterior casing, the first annular retention device engages the first crimp which prevents axial translation of the first annular retention device;
a second annular retention device positioned axially to the flexible fluid conveyance tube and engages the flexible fluid conveyance tube, the second annular retention device extends radially in the direction of the exterior casing;
a gasket disposed axially between the first annular retention device and the second annular retention device, and disposed radially between the flexible fluid conveyance tube and the exterior casing;
a second crimp extends radially interior from the interior surface of the exterior casing and engages the second annular retention device, the second crimp secures the gasket between the first and second annular retention devices, such that the gasket forms a fluid tight seal between the flexible fluid conveyance tube and the exterior casing.

2. The transition fitting of claim 1, wherein the stiffener and the second annular retention device are integrally formed.

3. The transition fitting of claim 2, further comprising an adapter head, wherein the adapter head, second annular retention device, and stiffener are integrally formed.

4. The transition fitting of claim 3, wherein the adapter head is threaded and extends away from the second end of the flexible fluid conveyance tube and extends exterior of the exterior casing.

5. The transition fitting of claim 1, further comprising an adapter, wherein the adapter is integrally formed with the exterior casing.

6. The transition fitting of claim 1, wherein the gasket further comprises a relaxed state and a compressed state, the gasket movable between the relaxed state and the compressed state by the application of an axial force.

7. The transition fitting of claim 6, wherein when the gasket is in the relaxed state, the gasket extends from the first annular retention device axially past the lust end of the flexible fluid conveyance tube.

8. The transition fitting of claim 6, wherein an axial force is applied to the second annular retention device to move the gasket from the relaxed state into the compressed state and the second crimp engages the second annular retention device to retain the gasket in the compressed state.

9. The transition fitting of claim 8, wherein when the gasket is in the compressed state, the gasket applies a radial force against the flexible fluid conveyance tube and the exterior casing, to create the fluid tight seal.

10. The transition fitting of claim 9, wherein the fluid tight seal further comprises a seal between the flexible fluid conveyance tube and the stiffener.

11. The transition fitting of claim 8, wherein the gasket in the compressed state is compressed to at least 1000 psi.

12. The transition fitting of claim 1, wherein the first annular retention device is elongated in an axial dimension and further includes as tapered surface that tapers radially away from the exterior casing.

13. The transition fitting of claim 12, wherein the first crimp engages the tapered surface of the first annular retention device.

14. A transition fitting, comprising:
an exterior casing;
a flexible fluid conveyance tube having a first end terminating at a fluid source and a second end terminating within the exterior casing, the flexible fluid conveyance tube being radially disposed at least partially within the exterior casing;
a first annular retention device radially disposed between the flexible fluid conveyance tube and the exterior casing;
a stiffener is located radially interior to the flexible fluid conveyance tube, the stiffener comprising a second annular retention device that extends radially outward in the direction of the exterior casing along the second end of the flexible fluid conveyance tube;
an elastomeric gasket radially disposed between the flexible fluid conveyance tube and the exterior casing and axially disposed between the first annular retention device and the second annular retention device;
a first radial crimp in the exterior casing engages the first annular retention device and prevents axial displacement of the first annular retention device in the direction of the first end of the flexible fluid conveyance tube; and
a second radial crimp in the exterior casing, wherein an axial force is applied to the first annular retention device, placing the elastomeric gasket in an axially compressed condition, and the second radial crimp engages the second annular retention device to secure the elastomeric gasket in the axially compressed condition.

15. The transition fitting of claim 14, wherein the stiffener further comprises a threaded head that extends away from the second end of the flexible fluid conveyance tube and extends exterior of the exterior casing.

16. The transition fitting of claim 14, wherein the first annular retention device is a grip ring comprising an elongated dimension in the axial direction and the grip ring varies in radial thickness along the elongated dimension.

17. A method of forming a transition fitting between a flexible fluid conveyance tube and an exterior casing, the method comprising:
crushing a first radial crimp in the exterior casing, the first radial crimp extending radially interior of the exterior casing;
positioning the flexible fluid conveyance tube within the exterior casing;
inserting a first annular retention device and a gasket radially between the fluid conveyance tube and the exterior casing;
inserting a stiffener into the flexible fluid conveyance tube;
inserting a second annular retention device radially interior of the exterior casing;
applying an axial force against the second annular retention device and stiffener;
compressing the gasket to a target hydraulic pressure;
positioning, a crimper relative to the second annular retention device;
crushing a second radial crimp into exterior casing, the second radial crimp engaging the second annular retention device.

18. The method of claim 17, wherein compressing the gasket further comprises compressing the gasket axially between the first and second annular retention device.

19. The method of claim 18, further comprising applying a radial force with the compressed gasket against the flexible fluid conveyance tube and the stiffener.

20. The method of claim 19, further comprising establishing a fluid tight seal between the flexible fluid conveyance tube and the exterior casing.
